(19) United States
(12) Patent Application Publication
(10) Pub. No.: US 2025/0297068 A1
(43) Pub. Date: Sep. 25, 2025

(54) ZWITTERION FUNCTIONALIZED COPOLYMERS FOR REVERSE OSMOSIS BRINE DESALINATION USING PERVAPORATION

(71) Applicants: Husain Mithaiwala, Tempe, AZ (US); Matthew Green, Phoenix, AZ (US)

(72) Inventors: Husain Mithaiwala, Tempe, AZ (US); Matthew Green, Phoenix, AZ (US)

(21) Appl. No.: 19/084,294

(22) Filed: Mar. 19, 2025

Related U.S. Application Data
(60) Provisional application No. 63/567,271, filed on Mar. 19, 2024.

(51) Int. Cl. C08G 75/23; B01D 61/36; B01D 67/00; B01D 69/02; B01D 69/10; B01D 71/68

(52) U.S. Cl. CPC C08G 75/23; B01D 61/362; B01D 61/366; B01D 67/0013; B01D 69/02; B01D 69/108; B01D 71/68; B01D 2323/081; B01D 2325/34

(57) ABSTRACT

Synthesizing zwitterionic-functionalized polysulfone copolymer includes reacting bisphenol A, 2,2′-diallyl bisphenol A, and 4,4′-difluorodiphenyl sulfone to yield a poly(arylene ether sulfone) polymer including allyl groups, modifying the allyl groups to yield a poly(arylene ether sulfone) polymer including tertiary amine groups, and modifying the tertiary amine groups to yield a copolymer including poly(aryl ether sulfone) and sulfobetaine arylene ether sulfone, wherein the sulfobetaine arylene ether sulfone is bonded to the poly(arylene ether sulfone) backbone. A zwitterionic-functionalized polysulfone copolymer includes poly(arylene ether sulfone) and sulfobetaine arylene ether sulfone. The sulfobetaine arylene ether sulfone is bonded to the poly(arylene ether sulfone) backbone, and a relative number average molecular weight of the zwitterionic-functionalized polysulfone copolymer is typically in a range of about 80 kDa to about 165 kDa.

### CROSS-REFERENCE TO RELATED APPLICATION

This application claims the benefit of U.S. Patent Application No. 63/567,271 filed on Mar. 19, 2024, which is hereby incorporated by reference in its entirety.

### STATEMENT OF GOVERNMENT SUPPORT

This invention was made with government support under 1836719 awarded by the National Science Foundation. The government has certain rights in the invention.

### TECHNICAL FIELD

This invention relates to pervaporation desalination using zwitterion-functionalized poly(arylene ether sulfone) copolymer membranes.

### BACKGROUND

Desalination of seawater and brackish ground water can augment freshwater supply. Desalination works by selectively removing salt from non-potable saline feeds such as brackish water, seawater, and concentrated brine solutions.

### SUMMARY

This disclosure describes preparation of sulfobetaine-modified poly(arylene ether sulfone) copolymer membranes and pervaporation desalination using these membranes. The poly(arylene ether sulfone-co-sulfobetaine arylene ether sulfone) (PAES-co-SBAES) membranes have high molecular weight copolymers with tunable charge (e.g., sulfobetaine) densities that can be selected according to aqueous feed conditions. For example, the molecular weight of allyl-modified poly(arylene ether sulfone) (PAES-co-APAES) copolymers can be systematically tuned to achieve the desired mechanical properties for particular desalination applications. Optimized high molecular weights can be achieved by increasing the monomer concentration and overhead stirring along with changes in the stoichiometric ratios between aryl halides and aryl phenols. The PAES(YY)-co-APAES(XX) (where, XX=mol % of zwitterion functionality and YY=100−XX) copolymers can then be functionalized to PAES(YY)-co-SBAES(XX) copolymers having increasing charge concentrations and cast to form hydrophilic dense selective standalone membranes. Hydrophilic assessments of PAES-co-SBAES membranes obtained through dynamic vapor sorption analysis and surface free analysis confirm that the water sorption capacity and polar components increase as the zwitterion (sulfobetaine) functionalization level increases.

The membranes described herein have exceptional salt rejection (>99.9% for concentrated reverse osmosis reject brine feed, >70000 mg/L of total dissolved solids) and excellent water permeance and permeability with concentrated saline feed without loss in permeance performance compared to commercial membranes. The polysulfone backbone ensures the physical strength of the dense membranes to be used in acidic, basic and oxidative feed conditions without hampering membrane performance. These membranes are scalable and can be transformed into high surface area to volume ratio morphology electrospun mats.

In a first general aspect, synthesizing zwitterionic-functionalized polysulfone copolymer includes reacting bisphenol A, 2,2′-diallyl bisphenol A, and 4,4′-difluorodiphenyl sulfone to yield a poly(arylene ether sulfone) polymer including allyl groups, modifying the allyl groups to yield a poly(arylene ether sulfone) polymer including tertiary amine groups, and modifying the tertiary amine groups to yield a copolymer including poly(aryl ether sulfone) and sulfobetaine arylene ether sulfone, wherein the sulfobetaine arylene ether sulfone is bonded to the poly(arylene ether sulfone) backbone.

Implementations of the first general aspect may include one or more of the following features. In some cases, the copolymer includes about 1 mol % to about 99 mol % sulfobetaine arylene ether sulfone. A number average relative molecular weight of the sulfobetaine modified poly(aryl ether sulfone) copolymer is typically in a range of about 3 kDa to about 165 kDa. In certain implementations, modifying the allyl groups includes a thiol-ene click reaction. Modifying the tertiary amine groups typically includes a ring opening reaction of a 1,3-propanesultone on the tertiary amine groups.

In a second general aspect, a membrane includes a zwitterionic-functionalized polysulfone copolymer prepared according to the first general aspect.

In a third general aspect, preparing a membrane including the zwitterionic-functionalized polysulfone copolymer of the first general aspect includes forming a solution including the copolymer, casting the solution to yield a membrane precursor, and drying the membrane to yield the membrane.

Implementations of the third general aspect may include one or more of the following features. In some cases, the copolymer is dried before forming the solution. In one example, the solution further includes dimethylformamide. Drying the membrane can include heating the membrane precursor at a temperature in a range from about 20° C. to about 80° C.

In a fourth general aspect, a membrane can be prepared according to the third general aspect.

In a fifth general aspect, a pervaporation module includes the membrane of the fourth general aspect.

Implementations of the fifth general aspect may include one or more of the following features. In some cases, a salt rejection of the membrane exceeds 99% for brackish water, seawater, and reverse osmosis brine. The membrane can be supported by a porous stainless-steel frit plate. In some implementations, a first side of the pervaporation module is continuously circulated with a feed solution. The feed solution can include deionized water, a saline solution, or any combination thereof. In one example, the saline solution is prepared with total dissolved solids ranging from about 10000 ppm to about 75000 ppm. The second side of the pervaporation module can be drawn with a vacuum.

In a sixth general aspect, a zwitterionic-functionalized polysulfone copolymer includes poly(arylene ether sulfone) and sulfobetaine arylene ether sulfone. The sulfobetaine arylene ether sulfone is typically bonded to the poly(arylene ether sulfone) backbone, and a relative number average molecular weight of the zwitterionic-functionalized polysulfone copolymer is typically in a range of about 80 kDa to about 165 kDa.

Implementations of the sixth general aspect may include the following feature. In some cases, the copolymer includes about 1 mol % to about 99 mol % sulfobetaine arylene ether sulfone.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a reaction pathway utilized to synthesize zwitterionic (sulfobetaine) functionalized polysulfones.

FIG. 2 is a drop casting method of fabricating a dense membrane of (PAES-co-SBAES) copolymers in a petri-dish.

FIG. 3A is a schematic of the pervaporation process and bench-scale system utilized in the desalination assessment. FIG. 3B is a schematic diagram of the pervaporation process inside the pervaporation cell.

FIG. 4 shows normalized differential refractive index traces from size exclusion chromatography for commercial membrane grade polysulfone (Udel PSf), the PAES(75)-co-APAES(25) (also denoted as AP25-M) membrane, and the PAES(50)-co-APAES(50) membrane (also denoted as AP50-M). Molecular weights were estimated using polystyrene standards ranging from 5 kDa to 200 kDa.

FIG. 5 shows normalized differential refractive index traces versus elution time plots for PAES(50)-co-APAES(50) copolymer at different reaction times (t=6, 12 and 18 hours) and different post-processing techniques to remove cyclic content from synthesized copolymer.

FIG. 6 shows normalized differential refractive index traces versus elution time plots for PAES(75)-co-APAES(25) copolymer synthesized at different weight percent concentration of monomers in N,N-dimethylacetamide (DMAc) and dimethyl sulfoxide (DMSO) polar aprotic solvents. Molecular weights were estimated using polystyrene standards ranging from 5 kDa to 200 kDa.

FIG. 7 shows normalized differential refractive index traces versus elution time plots for PAES(YY)-co-SBAES(XX) copolymer series prepared at 25 wt % solids (monomers) concentration and same 2,2′-diallyl bisphenol A (DABA) concentrations in DMAc solvent. The molecular weights were estimated on a different size exclusion chromatography system using polystyrene standards (5-200 kDa).

FIG. 8A shows thermogravimetric-sorption analysis of dense PAES(75)-co-SBAES(25) (denoted as SBAES(25)), PAES(50)-co-SBAES(50) (denoted as SBAES(50)), and PAES(25)-co-SBAES(75) (denoted as SBAES(75)) copolymers at relative humidity percentages (% RH) ranging from 0% to 95% at 25° C. FIG. 8B shows that the weight (%) gain for a PAES(50)-co-SBAES(50) copolymer macroporous bead had a higher absorption capacity compared to the corresponding dense membrane.

FIG. 9 shows a surface energy plot including polar and dispersive components for dense membranes evaluated using deionized water and diiodomethane.

FIG. 10 shows water permeance, P_{w} (kg/m²·h·bar) and permeability, Pᵢ (kg/m·h·bar) for Udel PSf, PAES(YY)-co-SBAES(XX) (denoted as SBAES(XX)) copolymers and DeltaMem from deionized water pervaporation assessments.

FIG. 11 shows composite water permeance (kg/m²·h·bar) chart of PAES(75)-co-SBAES(25) (denoted as SBAES(25)), PAES(50)-co-SBAES(50) (denoted as SBAES(50)), and PAES(25)-co-SBAES(75) (denoted as SBAES(75)) dense membranes for deionized water (DI), brackish water, seawater and reverse osmosis brine feed solutions from pervaporation. Order from left to right is indicated in the legend.

FIG. 12 shows salt rejection (SR %) for PAES(75)-co-SBAES(25) (denoted as SBAES(25)), PAES(50)-co-SBAES(50) (denoted as SBAES(50)), and PAES(25)-co-SBAES(75) (denoted as SBAES(75)) and DeltaMem membranes for synthetic brackish water, seawater and reverse osmosis brine desalination assessments. Order from left to right is indicated in the legend.

FIGS. 13A, 13B, and 13C show an illustration of the anti-polyelectrolyte effect experienced by polyzwitterionic membranes on its interaction with brine solutions in desalination pervaporation.

### DETAILED DESCRIPTION

This disclosure describes preparation of sulfobetaine-modified poly(arylene ether sulfone) copolymer membranes and pervaporation desalination using the membranes. Pervaporation achieves separation of dissolved solids from water by a difference in the vapor pressure across a dense selective membrane between the feed and permeate side. Continuous abstraction of the vapor permeates establishes a concentration gradient across the dense membrane surface which promotes the diffusion of water. The resulting concentration gradient acts as a driving force and is related to the partial vapor pressures in the feed and permeate vapor phase. Incorporation of hydrophilic membranes enables selective transport of water across the membrane and facilitates rejection of non-volatile species.

Zwitterions, neutral molecules with equal numbers of positively and negatively charged functional groups, have low fouling behavior and strong hydration capacities that render them superhydrophilic. Zwitterions can electrostatically interact with water molecules to form a hydration layer that inhibits preferential adsorption of contaminants and mitigates scaling. Zwitterion-membrane separation processes are resistant to protein adsorption and bacteria attachment and reduce adsorption of scale-forming ions due at least in part to a lower electrostatic attraction to the membrane surface. Thus, the combination of pervaporation and zwitterion chemistry can provide synergistic advantages for desalination membranes.

This disclosure describes a reaction pathway to prepare an amphiphilic copolymer poly(arylene ether sulfone-co-sulfobetaine arylene ether sulfone) (PAES-co-SBAES) with controllable charge densities of sulfobetaine zwitterion and linear high molecular weights. The PAES-co-SBAES copolymers are fabricated into dense membranes for performance characterization for desalination by pervaporation. The PAES-co-SBAES copolymer is tested with various concentrations of synthetic saline solutions to evaluate salt rejection capabilities. The results demonstrate salt rejection levels greater than 99.9% for a concentrated reverse osmosis brine feed of approximately 75000 mg/L of total dissolved solids. These membranes also show improved water permeance and permeabilities for concentrated saline feed without significant loss in permeance compared to some commercial membranes.

Preparation of the membranes includes bulk modification of zwitterions on PAES backbone, thereby improving the permselectivity of water and ions diffusing through the dense membranes while keeping them chlorine tolerant for harsh feed conditions in pervaporation. To dispense PAES-co-SBAES copolymers as stand-alone pervaporation membranes with desired mechanical properties, linear high molecular weights are selected, and the zwitterion charge is varied to increase the hydrophilicity of the PAES-co-SBAES copolymer. The resulting PAES-co-SBAES membranes are treated with different saline feed solutions to assess permselectivity efficiency for desalination pervaporation.

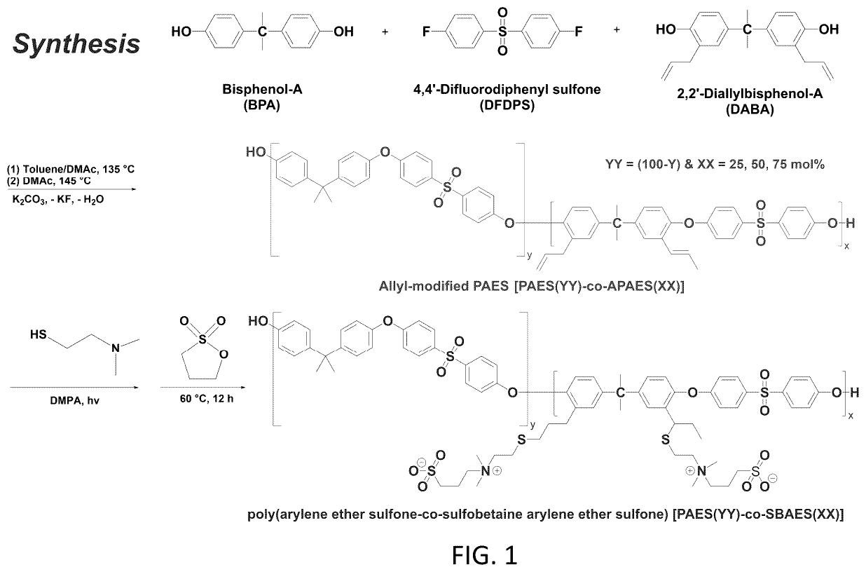

The synthetic reaction pathway of zwitterionic (sulfobetaine) functionalized polysulfones is shown in FIG. 1. The synthesis of PAES-co-SBAES copolymer includes several steps. A first step involves polycondensation reaction to form an allyl-modified poly(arylene ether sulfone) (PAES-co-APAES). In one example, bisphenol A (BPA), 2,2′-diallyl bisphenol A (DABA), 4,4′-difluorodiphenyl sulfone (DFDPS), and potassium carbonate (K₂CO₃) are used in the reaction. K₂CO₃ is dried at 120° C. for 24 hours and the monomers are dried for 48 hours in the freeze-dryer to ensure removal of moisture before initiating the reaction.

Initially, the polycondensation reaction between the di-aryl halides (e.g., DFDPS) and di-phenols (e.g., BPA and DABA) with 1:1 stoichiometry is initiated in the presence of a weak base (e.g., K₂CO₃) in a toluene-dimethylacetamide solvent system. After dissolving the monomers in the solvent, the reaction temperature is increased to 135° C. and maintained for 2 to 4 hours under constant N₂ atmosphere to remove the toluene-water azcotrope completely from the reaction. The temperature is increased and maintained at 145° C. for 6 hours until reaction completion. The reaction mixture is diluted with 5 volumes of chloroform and passed through a diatomaceous earth packed bed to remove the excess salts. A 1M hydrochloric acid in tetrahydrofuran solution is added to the reaction mixture until a color changed is observed from dark brown to pale yellow, noting the termination of the polycondensation reaction. Excess chloroform is removed with a rotary evaporator to concentrate the reaction solution to about 15 wt % to 20 wt %. The PAES-co-APAES copolymer is precipitated in methanol and dried at 80° C. under vacuum for 24 hours. Following this protocol, a series of copolymers are synthesized by changing the ratio of BPA and DABA (e.g., 3:1, 1:1 and 1:3) participating in the polycondensation reaction to make PAES(75)-co-APAES(25), PAES(50)-co-APAES(50) and PAES(25)-co-APAES(75). The number and weight average molecular weight of these synthesized monomers are estimated with size exclusion chromatography using 5 kDa to 200 kDa polystyrene standards and reference dn/de values.

A second step involves a post-polymerization modification reaction on the allyl functionalities to synthesize a tertiary amine-modified PAES(PAES-co-TAPAES) copolymer via a thiol-ene click reaction. The PAES-co-APAES copolymer is dissolved in dimethylformamide to make a 5 wt % solution in a round bottom reactor. To this, a 5-molar excess of 2-(Dimethylamino) ethanethiol hydrochloride is added along with a 0.3 molar photo-initiator 2,2-Dimethoxy-2-phenylacetophenone. The reactor is stirred and purged with N₂ gas for 30 minutes. The reaction mixture is placed in an ultraviolet box holding a 365 nm ultraviolet lamp and a magnetic stirrer. The reaction is performed at room temperature under an ultraviolet light for 5 hours or until all the allyl functionalities are converted to tertiary amine groups to yield PAES-co-TAPAES copolymer. The reaction mixture is filtered to remove any excess thiol groups and concentrated to 15 wt % using a rotary evaporator. PAES-co-TAPAES copolymer is precipitated in deionized water and further dried at 100° C. under vacuum. The TA-PAES copolymer is redissolved in dimethylformamide and re-precipitated in deionized water to remove any trace impurities from the copolymer. The final PAES-co-TAPAES is dried at 100° C. under vacuum for about 24 hours to 48 hours.

A third step involves a ring opening reaction of a 1,3-propanesultone on the tertiary amine groups of PAES-co-TAPAES copolymer to yield sulfobetaine modified poly(aryl ether sulfone) copolymer. The PAES-co-TAPAES copolymer is dissolved in dimethylformamide to make an 8 wt % concentration in a round bottom reactor. To this, a 2-molar excess of 1,3-propanesultone is added. The reaction is stirred for an hour at room temperature and for 12 hours at 60° C. The obtained PAES-co-SBAES copolymer is precipitated in isopropyl alcohol. The PAES-co-SBAES copolymer is filtered and re-washed with isopropyl alcohol to remove excess reagents and dimethylformamide. The final product is dried at 100° C. under vacuum for 72 hours and stored in moisture free conditions. With this protocol, three different charge percent zwitterionic (sulfobetaine) copolymers are prepared. In one implementation, PAES(75)-co-SBAES(25), PAES(50)-co-SBAES(50), and PAES(25)-co-SBAES(75) are synthesized.

Each of the PAES-co-SBAES copolymer in the series are converted to standalone dense selective membranes for desalination assessments with pervaporation and high-pressure fouling studies with reverse osmosis.

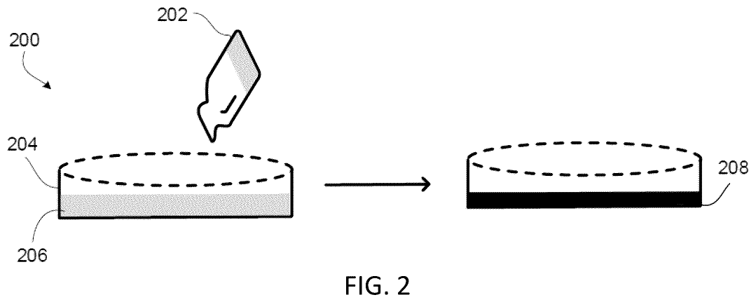

FIG. 2 depicts a membrane fabrication process described in Example 2, which uses a drop casting method 200. A solution 202 includes copolymers. The solution 202 is added to container 204 (e.g., a petri-dish) and a membrane precursor 206 is formed. The membrane precursor 206 is dried to yield membrane 208.

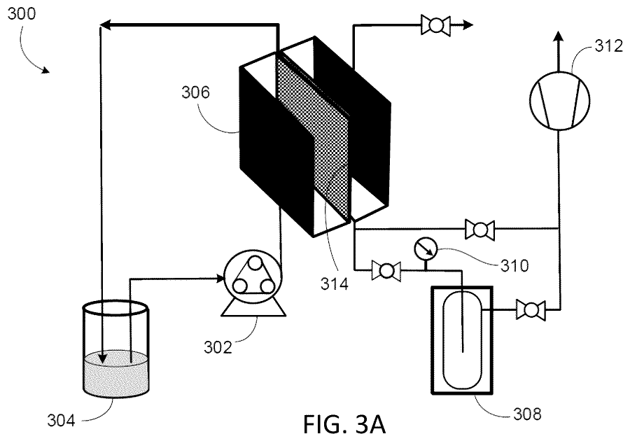

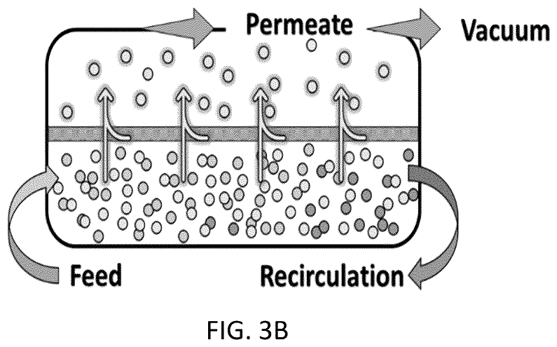

FIG. 3A depicts a pervaporation measurement system 300 described in Example 5.

The system 300 includes a recirculation feed stream through a peristaltic pump 302, a feed solution 304 (e.g., deionized water, saline solution), a pervaporation cell 306, a cold trap 308, a vacuum gauge 310, and a vacuum pump 312. A membrane 314 is supported with a porous stainless-steel frit plate inside the pervaporation cell 306. One side of the pervaporation cell 306 is provided with (e.g., continuously circulated) the feed solution 304. The other side of the pervaporation cell 306 is drawn with the vacuum pump 312 to provide a vapor pressure gradient. After equilibration of the membrane 314, a permeate is collected under vacuum for salt removal analysis.

### EXAMPLES

### Materials and Methods

2,2′-diallylbisphenol A (DABA, 85%), N,N-dimethylacetamide (DMAc, 99.5%), 2,2-dimethoxy-2-phenylaceto-phenone (DMPA, 99%), diiodomethane (ReagentPlus®, 99%), diatomaceous earth (Celite® 545), 1,3-propanesultone (98%), deuterated dimethyl sulfoxide, (DMSO-d6, 99.9 atom % D, 0.03% (v/v) TMS) were purchased from Sigma-Aldrich and were used as received. Potassium carbonate (K₂CO₃, ≥99%) was purchased from Sigma-Aldrich. Potassium carbonate was baked at 130° C. until it was transferred to the reaction. Bisphenol A (BPA, ≥99%), bis(4-fluorophenyl) sulfone (DFDPS, 99%), deuterated chloroform (CDCl₃, 99.8 atom % D, 0.03% (v/v) TMS), 2-(dimethylamino)-ethanethiol hydrochloride (95%) were purchased from Thermo Scientific and used as received. Hydrochloric acid (HCl, 36.5-38%), methanol (MeOH, 99%), isopropyl alcohol (IPA, 99%), and tetrahydrofuran (THF, 99%) were purchased from VWR and used as received. Toluene (99.9%) and THF Optima™ were purchased from Fisher Scientific and used after passing through an MBraun SPS-800 solvent purification system. Ultrapure water was dispensed from a Milli-Q® water purification system. Narrowly distributed (Ð˜1) 200 kDa and 30 kDa polystyrene standards were purchased from Pressure chemical company (Pittsburgh, PA) and 482 kDa, 91,450 Da, 9,820 Da and 4,910 Da polystyrene standards were purchased from Agilent technologies and used as received. Udel® P-1700 NT 11 polysulfone (Udel PSf) pellets were provided by Solvay specialty polymers and used as received.

¹H NMR spectra were recorded on a Varian 500 MHz spectrometer for structural analysis. CDCl₃ was used as a solvent for Udel PSf and PAES(YY)-co-APAES(XX), and DMSO-do for PAES(YY)-co-TAPAES(XX) and PAES(YY)-co-SBAES(XX). NMR samples were prepared by dissolving 20 mg of dried polymer in 0.7 g of deuterated solvent and filtering them through a 0.45 μm Teflon filter.

Size exclusion chromatography, utilizing an e2695 HPLC system interfaced with a Wyatt miniDAWN TREOS light scattering detector and a Wyatt Optilab T-rEX differential refractive index detector, was performed at a flow rate of 1 mL per minute in THF Optima™ to determine molecular weight relative to polystyrene standards. A water size exclusion chromatography, using three 5 μm PLgel Mixed-C columns connected to a Waters 2410 refractive index detector, was also used with a flow rate of 1 mL per minute in CHCl₃. Reference dn/dc values were used to estimate absolute molecular weight. The cyclic oligomers concentrations with size exclusion chromatography traces were measured by the ratio of area under the curve of cyclic shoulder peak versus total area in the elution trace.

Imaging for surface and cross-sectional morphologies were characterized using a FEI Nova 200 NanoLab field emission scanning electron microscopy system. The accelerating voltage was set between 10 kV and 20 kV with a probe current of 0.54 nA to 2.1 nA using the Everhart Thornley detector at a working distance of 5.0 mm.

Sorption analysis on dense membranes was performed on Discovery SA-0155 with an equilibration step of 60° C. with no relative humidity to dry the samples. The samples were cooled to 25° C. if the relative humidity was less than 0.05% for 10 minutes. The relative humidity was increased to 95% at 25° C. until a weight percentage change was less than 0.05% for 10 minutes. Prior to sorption analysis assessments, membranes were dried at 100° C. under vacuum for 24 hours.

Contact angle measurements were performed on a rame-hart goniometer/tensiometer Model 790 with DROPimage Advanced software. A Hamilton 1750TPLT 0.5 mL, PLNGR TYPE syringe along with a 16-gauge stainless steel needle was used to dispense a 5 μL droplet for each solvent. Dense membranes were stuck to a glass slide using a permanent double-sided scotch tape for flatness. For each membrane, 10 measurements were taken every 3 seconds at 5 different locations, starting after 30 seconds of dispensing the droplet on each SBAES(XX) dense membrane. Surface energies in mJ/m² were calculated using 2-Liquid (Extended Fowke's/WORK) method on the DROPimage Advanced software.

### Example 1. Synthesis of Zwitterionic Functionalized Polysulfones

The reaction pathway shown in FIG. 1 was used to synthesize zwitterionic functionalized polysulfones. The synthesis of a random PAES(YY)-co-APAES(XX) (where, XX=mol % of zwitterion functionality and YY=100-XX) copolymer is achieved by a three-step process.

The first step of the reaction pathway was synthesizing allyl-modified random poly(arylene ether sulfone), PAES(75)-co-APAES(25). Monomers DABA (2 g, 6.49 mmol), BPA (4.44 g, 19.46 mmol), DFDPS (6.6 g, 25.94 mmol) were added to a 100 mL parallel 3-necked round bottom reactor. The monomer stoichiometry was 1:1 between di-aryl halides and di-aryl phenols but was varied to assess the impact on cyclic oligomers. Additionally, PAES(50)-co-APAES(50) and PAES(25)-co-APAES(75) were synthesized by tuning the DABA/BPA ratio to 1/1 and 3/1, respectively. Monomers were freeze-dried for 48 hours to ensure removal of moisture. The reactor was equipped with a mechanical stirrer assembly, Chem-Stir®, with a polytetrafluoroethylene blade (19 mm×48 mm) and a stirrer shaft (10 mm outer diameter×455 mm length) along with a 24/40 bearing support. A Dean-stark assembly was attached together with a reflux condenser and nitrogen inlet and outlet tubes for purging. Prior to reaction, DMAc (39.4 mL, 25 wt % with respect to monomers) was added to dissolve the monomers Toluene (19.8 mL) was added as an azeotropic agent to remove water, which was a by-product of the step growth reaction. The Dean stark assembly was filled with toluene to the neck to assist in the toluene-water azeotrope removal. K₂CO₃ (8.60 g, 62.23 mmol) baked at 130° C. was added to the reaction solution followed with nitrogen purging and stirring for 45 minutes before lowering the round bottom reactor in an oil bath equipped with a thermometer. The reaction temperature was increased to 135° C. and maintained for 4 hours under constant N₂ purging to dehydrate the reaction mixture by refluxing the toluene-water azeotrope. Next, the temperature was increased to 145° C. to remove any residual toluene and maintained for 6 hours under static N₂ until reaction completion. The reaction mixture was then allowed to cool to room temperature and was diluted with 5 volumes of chloroform. 2 mL of a 2M HCl in THE solution was added to the reaction for neutralization of left over bis-phenolate salt. The mixture was passed through a diatomaceous earth slurry bed to filter inorganic salts. The product was isolated by precipitating in a methanol bath. The polymer PAES(75)-co-APAES(25) was filtered and dried under vacuum at 80° C. for 48 hours.

The second step of the reaction pathway was synthesizing tertiary amine-modified poly(arylene ether sulfone), PAES-co-TAPAES. The dried PAES(75)-co-APAES(25) (10 g, 9.5 mmol allyls), 2-(dimethylamino)-ethanethiol (7.2 g, 5 molar excess) and a photo-initiator DMPA (0.3 molar eq.) in 200 mL dimethylformamide were introduced to a 500 mL round bottom flask and allowed to stir for 1 hour under constant N₂ purging. The mixture was then isolated in a box and irradiated with a compact ultraviolet lamp (Analytik Jena US UVL-28 EL series at 365 nm) for 6 hours. The reaction mixture was then filtered and concentrated using a rotary evaporator to 10 wt % concentration. The modified product PAES(75)-co-TAPAES(25) was isolated by precipitation in an isopropyl alcohol bath and dried under vacuum at 80° C., dissolved in dimethylformamide, re-isolated in an isopropyl alcohol bath to remove impurities, and dried under vacuum at 80° C.

The third step of the reaction pathway was to synthesize sulfobetaine-modified poly(arylene ether sulfone), PAES-co-SBAES. PAES(75)-co-TAPAES(25) (10 g, 1 mmol) was dissolved in dimethylformamide (90 mL) along with 1,3-propanesultone (2 molar equivalent) to a 250 mL round bottom flask. The solution was stirred at room temperature for 1 hour and 60° C. for 12 hours. The final product was isolated by precipitating in a bath containing an excess of isopropyl alcohol. The PAES(75)-co-SBAES(25) copolymer was filtered and dried at 100° C. under vacuum for 48 hours.

Following the above protocol, 3 different copolymers labeled as PAES(75)-co-TAPAES(25), PAES(50)-co-TAPAES(50) and PAES(25)-co-TAPAES(75) were prepared with a 25 mol %, 50 mol % and 75 mol % sulfobetaine concentration, respectively.

### Example 2. Dense Membrane Fabrication

The drop casting method was used to make dense membranes of PAES(YY)-co-SBAES(XX) copolymers, as shown in FIG. 2. Prior to dissolution, the copolymers from Example 1 were dried for at least 72 hours for moisture removal. Dilute solutions between 1.5 wt % and 2.5 wt % were prepared by dissolving the copolymer in dimethylformamide (12 g) in a 20 mL vial. The vial was left as-is for 24 hours and sonicated and degassed for 30 minutes. The solution was passed through a 0.22 μm Teflon filter into a DURAN™ DUROPLAN 100×20 mm petri-dish and was left to equilibrate for 15 minutes. The petri-dish was placed inside a stage in the vacuum oven which was adjusted using a spirit level to ensure complete flatness. Dense membranes were created by eliminating all dimethylformamide from the petri dish using a gradual heating process, where each temperature of 22° C., 40° C., and 80° C. was maintained for at least 24 hours. The petri-dish was then placed in a deionized water bath to allow the membrane to swell and detach from the petri-dish. After peeling, the dense membranes were stored in deionized water prior to testing them with pervaporation assessments.

### Example 3. Polymer Characterization: Analysis of Stoichiometry and Reaction Conditions

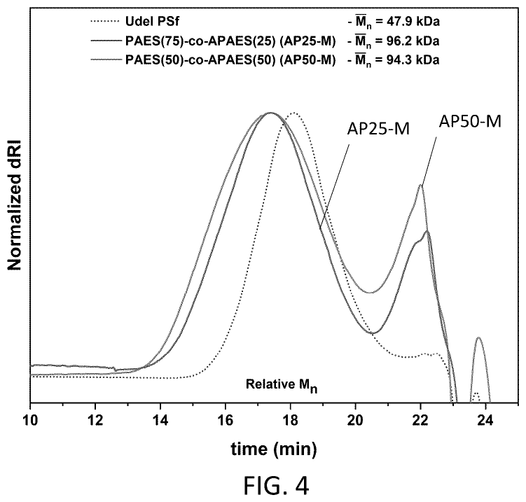

Using size exclusion chromatography, the molecular weight estimation was done on PAES(YY)-co-APAES(XX) copolymers before post-polymerization modifications to PAES(YY)-co-SBAES(XX) copolymers. FIG. 4 shows the normalized differential refractive index traces for a commercial membrane grade polysulfone (Udel PSf), PAES(75)-co-APAES(25), and PAES(50)-co-APAES(50) copolymers after completing a polycondensation reaction between the reactive halides and phenols, as described in FIG. 1. The number (M̅ₙ) and weight (M̅_{w}) average molecular weights for these copolymers were estimated using polystyrene standards ranging from 5 kDa to 200 kDa. The M̅ₙ for PAES(75)-co-APAES(25) (96.2 kDa) and PAES(50)-co-APAES(50) (94.3 kDa) polymers were higher than that of the Udel PSf (47.9 kDa). In the system described herein, high M̅ₙ and M̅_{w} was achieved by performing several iterative assessments by changing the molar ratio of DABA. This comparison provided an insight into achieving linear high molecular weights to qualify the resulting free-standing membranes for pressure-based applications. An addition of 1.05 molar excess of DABA monomers mimicked a 1:1 stoichiometry in the PAES(YY)-co-APAES(XX) model that enabled it to achieve high molecular weight chains. FIG. 4 shows the differential refractive index traces of PAES(75)-co-APAES(25) and PAES(50)-co-APAES(50) copolymers with a bi-modal molecular weight distribution. The shoulder peaks at higher elution times, approximately 22 minutes, in the size exclusion chromatography plots were attributed to cyclic oligomer chains that had formed during the step growth reaction. The formation of cyclic oligomers in step growth synthesis was known to arise due at least in part to backbiting of the extending chain ends to the polymer backbone in a kinetically controlled polycondensation reaction. Furthermore, in a kinetically controlled polycondensation reaction, cyclic formation can compete with chain propagation, and the cyclic formation can become pre-dominant when the reaction ratios are optimized (e.g., approximately a 1:1 stoichiometry) to achieve high molecular weight chains. Cyclic oligomers are seen in differential refractive index traces at elution times between 22 minutes and 23 minutes, as shown in FIG. 4. For this analysis, the area percent of the cyclic peak with respect to the main peak from the size exclusion chromatography plots were examined. A comparison of the cyclic concentrations showed that PAES(75)-co-APAES(25) and PAES(50)-co-APAES(50) polymers possessed a cyclic fraction of 18.01% and 20.75%, respectively. An increase in cyclic concentration was observed with increasing DABA concentration, attributed at least to the backbiting of polymer chains caused by the segmental motion of the allylic pendant groups on DABA. The cyclic oligomer identified in PAES(YY)-co-APAES(XX) copolymers were only quantitatively estimated rather than qualitatively (e.g., dimer, trimer).

In membrane dope solutions, the cyclic oligomers can impart cloudiness due at least in part to partial precipitation and crystallization over time, leading to imperfections on the membrane surface. Consequently, membranes prepared from identical solutions can show a variation in flux and rejection properties, an effect that could be coupled with the oligomers affecting its thermodynamic stability. Methods for cyclic removal, such as post-processing and synthetic techniques, were assessed. In the post-processing approach, the polymer solution was diluted to low concentrations (e.g., approximately 5 wt %) and was precipitated in different solvent and non-solvent baths, weak acid solutions, and centrifuged to fraction the low molecular weight cyclic oligomers from the linear chains. In the synthetic approach, the concentration of the solid (e.g., monomers) in the reaction was increased with respect to the solvent. In addition, the reaction time was increased, a polar aprotic solvent that had a higher viscosity and boiling temperature than DMAc was used, and overhead stirring was utilized.

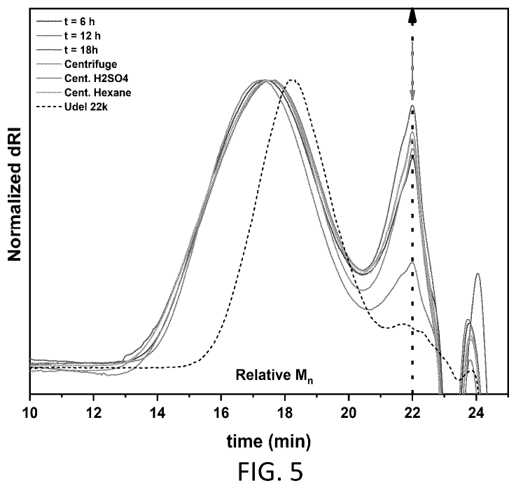

The effects of post-processing methods were assessed on the PAES(50)-co-APAES(50) copolymer and its differential refractive index traces are shown in FIG. 5. An increase in reaction time for step-growth reaction from t=6 hours to t=18 hours yielded negligible impact on the cyclic concentration. The main peak corresponding to linear molecular weight chains remained unaffected while the area of cyclic amounted to 20.75%, 11.7% and 23.07% for t=6 hours, 12 hours, and 18 hours, respectively. The low cyclic concentration at t=12 hours was attributed at least to the errors in the size exclusion chromatography sample preparation, since the cyclic area at t=6 hours and t=18 hours were constant around 20%. Additionally, a dilute solution of PAES(50)-co-APAES(50) (e.g., 3 wt % in CHCl₃) was precipitated in a non-solvent (e.g., methanol) bath and the precipitate was centrifuged. The precipitate was washed with non-solvents (e.g., 2 wt % sulfuric acid and hexane) to fraction out the cyclic chains from the linear chains. Referring to FIG. 5 and Table 1, the differential refractive index traces suggested that the tested methodologies rendered ineffective to segment the cyclic oligomers from PAES(50)-co-APAES(50) copolymer linear chains, where the quantitative estimates stayed nearly constant.

TABLE 1
Summary of cyclic area (%) calculated relative
to the main peak for cyclic concentration estimation
for PAES(50)-co-APAES(50) copolymer.

| PAES(50)-co-APAES(50) | Cyclic |
|---|---|
| 96.2 kDa, PDI = 3.15 | % |
| at t = 6 h | 20.75 |
| at t = 12 h | 11.7 |
| at t = 18 h | 23.07 |
| Centrifuge | 21.07 |
| Centrifuge + H₂SO₄ | 19.86 |
| Centrifuge + Hexane | 20.26 |
| Udel PSf | 7.04 |

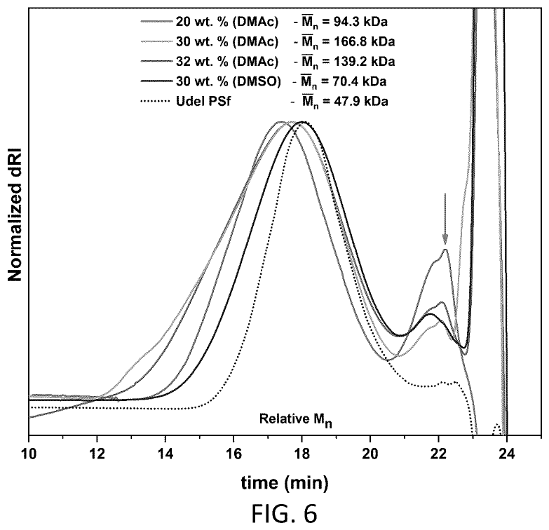

The effects of synthetic protocol modifications were assessed. The Ruggli-Ziegler Dilution method developed for optimization of macrocyclic yields suggests that any difunctional monomer or oligomer containing two complimentary functional groups has the choice to undergo (poly) condensation or cyclization during each step of conversion. The preference for cyclization was increased under high dilutions at least in part because it was an intramolecular (monomolecular) reaction. Thus, the monomer concentration was increased in conjunction with utilizing DMSO to afford the PAES(75)-co-APAES(25) copolymer step growth reaction with the intention to produce low cyclic oligomers. In addition, at increased concentrations, the magnetic stirrer was replaced with overhead stirring. This approach can eliminate cross-linking due at least in part to inadequate solution mixing caused by the increased viscosity of the elongating chains at higher reaction times (e.g., greater than t=2 hours). Additionally, incorporating DABA as a co-monomer in the material system can lead to cross-linking due at least in part to the presence of unsaturated allyl groups that are susceptible to undergo side reactions at higher concentrations. The M̅ₙ of PAES(75)-co-APAES(25) synthesized at 30 wt % and at 32 wt % in DMAc with overhead stirring was compared to the M̅ₙ of the PAES(75)-co-APAES(25) copolymer, synthesized at 20 wt % DMAc with magnetic stirring. Referring to FIG. 6 and Table 2, the values of M̅ₙ for PAES(75)-co-APAES(25) synthesized at 30 wt % and at 32 wt % in DMAc was higher, at around 166.8 kDa and 139.2 kDa, respectively. This synthesis protocol also reduced the fraction of cyclics from 18% to 8% and 11.1%, respectively. At a high monomer concentration (e.g., 32 wt %), a lower M̅ₙ was observed than the 30 wt % concentration. This is due at least in part to variation in the relative purity of the DABA co-monomer that influenced kinetics of the reaction. Replacing DMAc with a polar aprotic solvent, DMSO, at 30 wt % configurations resulted in a lower M̅ₙ of 70.4 kDa and a slightly higher cyclic fraction of 12.2%. The lower M̅ₙ in DMSO at the same monomer concentration of 30 wt % compared to DMAc, which was measured to be 166.8 kDa, was attributed to the slower reaction kinetics due at least in part to lower cation solvating power and decreased solubility of the weak base (e.g., K₂CO₃). However, the cyclic peak in the size exclusion chromatography differential refractive index trace for DMSO was at a slightly lower elution time, indicating that the resulting cyclic oligomer fraction was different from the one appearing in DMAc, as shown in FIG. 6. Nonetheless, there was an overall positive impact on the M̅ₙ of PAES(75)-co-APAES(25) copolymers by changing the concentration and stirring type.

TABLE 2
Summary of molecular weight analysis and cyclic area for PAES(75)-
co-APAES(25) calculated from differential refractive index traces
as a function of monomer concentration shown in FIG. 6.

| PAES(75)-co-APAES(25) | M̅ₙ | M̅_{w} | | Cyclic |
|---|---|---|---|---|
| (Overhead Stirring) | kDa | kDa | PDI | % |
| 20 wt % in DMAc | 94.3 | 310.2 | 3.29 | 18.01 |
| 30 wt % in DMAc | 166.8 | 673.9 | 4.04 | 8.00 |
| 32 wt % in DMAc | 139.2 | 444.0 | 3.19 | 11.15 |
| 30 wt % in DMSO | 70.4 | 205.6 | 2.92 | 12.22 |
| Udel PSf | 47.9 | 79.1 | 1.65 | 7.04 |

The click nature of the thiol-ene reaction promoted a network formation at least in part because of the rapid photo-initiated radical-mediated process between the multifunctional monomers. The two allyl-pendant groups in DABA co-monomer addressed the possibility of cross-linking in the ensuing conversion to PAES(YY)-co-TAPAES(XX) copolymers. Even with dilute solutions (e.g., less than 5 wt %) of the high M̅ₙ PAES(75)-co-APAES(25) copolymers (>100 kDa, relative M̅ₙ), the thiol-ene reaction at optimized photo-initiator (e.g., 0.1-0.3 eq.) and thiol concentrations (e.g., 3-10 eq.) led to gel formation. This observation indicated cross-links of the PAES(75)-co-APAES(25) backbone. The viscosity of high M̅ₙ even at dilute concentrations was recognized as a contributor to the observed cross-linking.

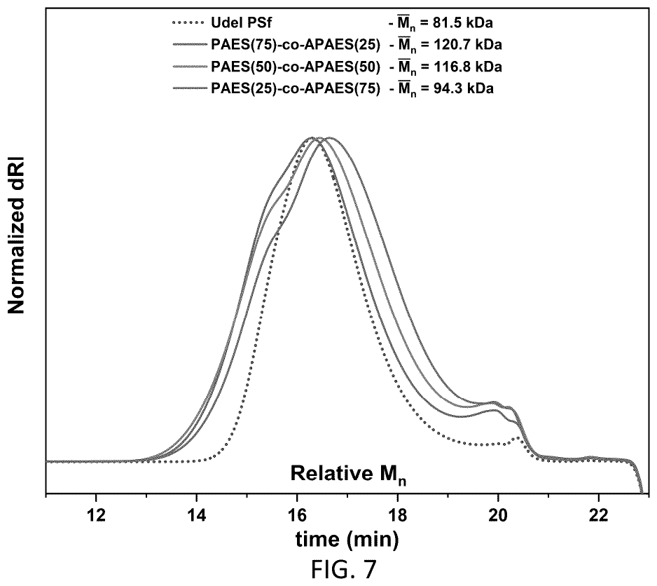

The monomer concentration was adjusted to 25 wt % to have a high M̅ₙ and lower cyclic fraction that would not pose challenges of cross-linking in the post-polymerization modification of the PAES(YY)-co-APAES(XX) backbone. At the 25 wt % monomer concentration with equivalent relative purity of DABA, the absolute M̅ₙ of the PAES-(75)-co-APAES(25), PAES-(50)-co-APAES(50), and PAES-(25)-co-APAES(75) copolymers were found to be 120.7, 116.8 and 94.3 kDa, respectively. The PAES-(75)-co-APAES(25), PAES-(50)-co-APAES(50), and PAES-(25)-co-APAES(75) copolymers had a cyclic fraction of 6.29%, 6.16% and 7.16%, respectively, as shown in FIG. 7 and Table 3.

TABLE 3
Summary of M̅ₙ, M̅_{w}, PDI and
cyclic fraction for synthesized PAES(YY)-co-SBAES(XX)
series with same initial DABA concentration.

| Polymer | M̅ₙ | M̅_{w} | | Cyclic |
|---|---|---|---|---|
| (Overhead Stirring) | kDa | kDa | PDI | % |
| Udel PSf | 81.5 | 131.3 | 1.61 | 2.03 |
| PAES(75)-co-APAES(25) | 120.7 | 271.4 | 2.24 | 6.29 |
| PAES(50)-co-APAES(50) | 116.8 | 297.1 | 2.54 | 6.16 |
| PAES(25)-co-APAES(75) | 94.3 | 250.2 | 2.65 | 7.67 |

The relative M̅_{w} and M̅ₙ values in FIG. 7 and Table 3 were obtained from a different size exclusion chromatography equipment and resulted in a change in the reported Udel PSf values. With this step change, a decrease in the overall cyclic fraction of the copolymer model was established. For example, the cyclic content of PAES-(75)-co-APAES(25) decreased from 18.01% to 6.29% when the monomer concentration increased from 20 wt % to 25 wt %. The molecular weight of a PAES-co-APAES copolymer can be tuned with a targeted charge content by relying on the performed molecular weight analysis with different conditions. Overall, the results disclosed herein enable an understanding of the trade-off between the high molecular weight chains and the accompanying cyclic oligomers for a step-growth reaction and the copolymer model. Utilizing the 25 wt % monomer concentration and overhead stirring, the PAES(YY)-co-APAES(XX) (XX=25, 50 and 75) copolymers were synthesized and modified to PAES(YY)-co-SBAES(XX) (XX=25, 50 and 75) copolymers for casting membranes and comparing their desalination performance.

### Example 4. Membrane Characterization

The drop casting method yielded dense membranes for PAES(75)-co-SBAES(25), PAES(50)-co-SBAES(50) and PAES(25)-co-SBAES(75) copolymers shown by their surface and cross-sectional scanning electron microscopy images. These membranes ranged in average thicknesses of 20 μm to 50 μm depending on the concentration (e.g., 1.5 wt % to 2.5 wt %) of the membrane dope solution. The surface morphology of the dense membrane appeared smooth and defect-free. Moreover, a smooth morphology will further aid in resisting deposition of scalants and foulants when dispensed for performance evaluation. The bulk morphology from the cross-section confirmed the dense characteristics without any presence of porous structures. The transport mechanism of water across these membranes relied on solution-diffusion. Nano-sized puncture holes, measuring less than 50 nm, were observed on both the surface and cross-section of the membranes. These holes were due at least in part to gradual solvent removal during the casting process. However, the holes typically did not run through the bulk of the membrane.

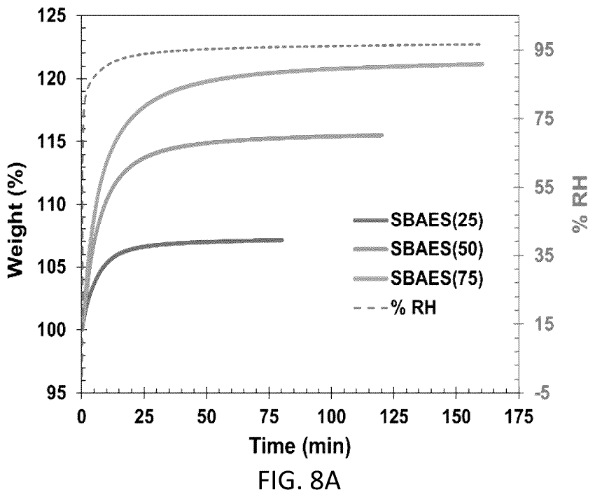

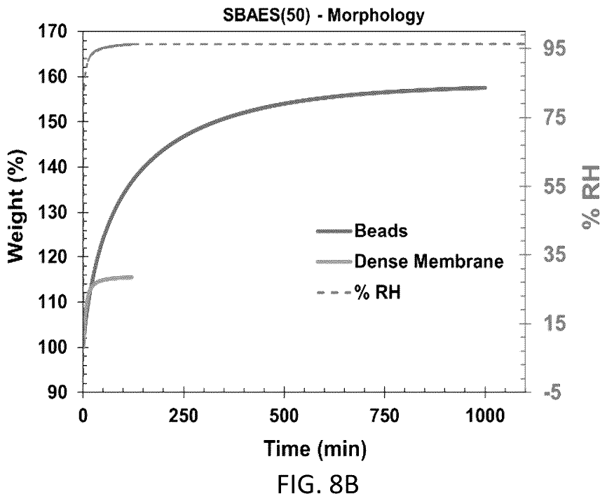

As a measure of hydrophilicity, the PAES(YY)-co-SBAES(XX) copolymer dense membranes series were subjected to thermogravimetric-sorption analysis at 25° C. by increasing the relative humidity from 0% to 95%. The sorption behavior for each of these membranes are shown in FIGS. 8A and 8B. Comparing the slopes of these membranes, the rate of absorption was instantaneous with the rate of change of relative humidity for each membrane. Referring to FIG. 8A, the absorption trend showed that PAES(25)-co-SBAES(75) membrane absorbed the highest moisture (e.g., 22%) followed by PAES(50)-co-SBAES(50) and PAES(75)-co-SBAES(25) membranes with 15.5% and 7.1%, respectively. Leading to the dense nature of these membranes, only the zwitterion functionalities on the surface electrostatically bind to water. Thus, a marginal weight increase was observed across all charged dense membranes. The bulk of the membrane typically remained inaccessible to the relative humidity at ambient conditions due at least in part to diffusion limitations. The hydrophilic properties were highlighted when different form factors with identical mass were compared for the same PAES(YY)-co-SBAES(XX) copolymer. The weight gain for a PAES(50)-co-SBAES(50) copolymer macroporous bead (e.g., approximately 1-2 mm) showed a higher absorption capacity of 58% compared to its dense membrane form that exhibited a gain of 15%, as shown in FIG. 8B. Additionally, the beaded sample continued absorbing moisture for more than 1000 minutes in contrast to its membrane form, which only absorbed moisture for about 115 minutes. This provided an insight into the hydration capacities of the PAES(YY)-co-SBAES(XX) copolymers at ambient conditions.

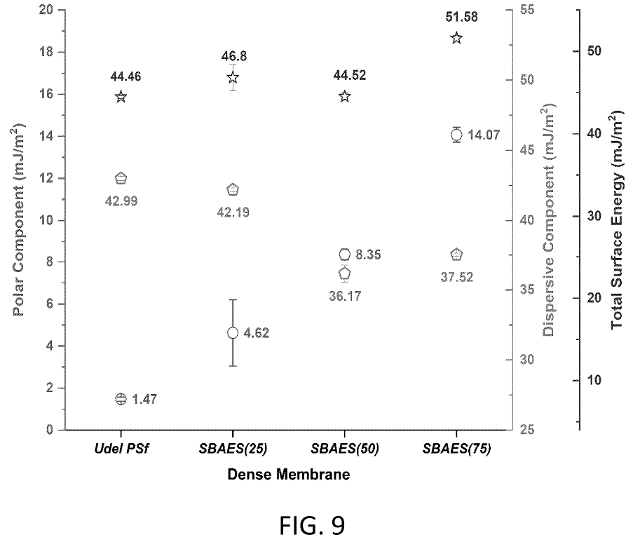

The zwitterion charges on the backbone were distributed in the bulk of these membranes instead of an active layer, which caused the membranes to swell until saturated with deionized water in contact-angle measurements. The baseline of the droplet dynamically changed, especially with deionized water. Therefore, the surface free energy of these membranes was assessed using the Extended Fowke's/OWRK method. This method involved predicting the total surface energy of a surface by dividing them into two components. The dispersive component accounted for weak surface interactions, such as van der Waals forces of attraction. The polar component accounted for other types of interactions, such as hydrogen bonding, dipole-dipole interactions, and induced dipole interactions. To evaluate these components, diiodomethane and deionized water were used as the probe solvents. Diiodomethane is a non-polar solvent (σ_{L}=σ_{L}^{D})=50.8 mN/m) with negligible polar component. Deionized water is a polar solvent (σ_{L}^{P}=46.4 mN/m, and σ_{L}^{D})=26.4 mN/m) having both polar and dispersive parts of surface tension. The estimated total surface free energy results are summarized in FIG. 9. The Udel PSf had a high dispersive component of 42.99 mJ/m² and a low polar component of 1.47 mJ/m². On the contrary, the PAES(75)-co-SBAES(25) membrane yielded a polar component of 4.62 mJ/m², higher than Udel PSf. The PAES(75)-co-SBAES(25) membrane had a similar dispersive energy with an overall increase in the total surface energy to 46.8 mJ/m². Likewise, the polar interactions for PAES(50)-co-SBAES(50) further increased to 8.35 mJ/m2, and a proportional decrease in the dispersive energy to 36.17 mJ/m² was observed. PAES(50)-co-SBAES(50) membrane maintained a relatively constant total surface free energy of 44.52 mJ/m². This resistance in change of the total surface energy was provided at least by the hydrophobic backbone. Lastly, the PAES(25)-co-SBAES(75) membrane exhibited the highest polar component of 14 mJ/m² due at least in part to the stronger hydration layer experienced during the deionized water measurements. However, the overall increase in total surface energy to 51.6 mJ/m² for PAES(25)-co-SBAES(75) membranes suggested a higher overall surface energy due at least in part to more zwitterionic species.

### Example 5. Pervaporation Assessments

Pervaporation measurements were conducted on a bench scale-system shown in FIG. 3A. The setup included a recirculation feed stream through a peristaltic pump, a feed reservoir, a two-compartment pervaporation cell, a dry ice-cold trap, a digital vacuum gauge and a high-capacity Edwards RV-5 vacuum pump. The membrane was supported with a porous stainless-steel frit plate (e.g., 20 μm) inside the cell with an active area of 3.9 cm×3.9 cm. One side of the cell was continuously circulated with feed solution while the other side was drawn with vacuum (e.g., approximately 10⁻⁴ torr) to provide a vapor pressure gradient, as shown in FIG. 3B. Each membrane was allowed to fully equilibrate with deionized water feed in conjunction with vacuum for 30 minutes before each assessment. After equilibration, the feed was replaced with fresh deionized water (e.g., 90 mL) and the permeate was collected for 1 hour under full vacuum. This procedure was reported 3 times for each membrane. Then, the deionized water feed was replaced with a saline solution. A total of 3 synthetic saline solutions were prepared with 10000 ppm, 32000 ppm and 75000 ppm of total dissolved solids mimicking brackish water, seawater and reverse osmosis brine, respectively. Similarly, triplicate measurements of 1 hour assessments were conducted for each membrane, cumulating a total of 12 assessments per membrane sample. Temperature for each assessment was recorded to estimate the equilibrium vapor pressure on the feed side. The permeate after each desalination protocol was collected in a 20 mL vial for conductivity measurements to estimate salt removal. The above protocol was repeated for a total of 3 membranes per each PAES(YY)-co-SBAES(XX) (XX=50 and 75) copolymer. Equations 1 to 4 were used to evaluate the following parameter with their average and standard deviation values reported for each PAES(YY)-co-SBAES(XX) copolymer membrane: water flux, J_{w} (kg m² h⁻¹), water permeance, P_{w} (kg m² h⁻¹ bar⁻¹) and water permeability, Pᵢ (kg m⁻¹ h⁻¹ bar⁻¹).

$${J}_{w} = \frac{W}{A Δ t} \qquad Eq . 1$$

J_{w} was the water flux calculated by normalized by the mass of the permeate (W, kg) with the active membrane area (A, m²) and duration of the assessment (Δt, h). The water permeance, P_{w} was calculated by normalizing the water flux with the differential vapor pressure (ΔP^{sat}, bar) across the membrane:

$${P}_{w} = \frac{W}{A Δ t Δ {P}^{sat}} \qquad Eq . 2$$

The differential water vapor pressure (ΔP^{sat}) was estimated by:

$$Δ {P}^{sat} = {x}_{w} {γ}_{w} {P}_{sat} \qquad Eq . 3$$

x_{w} was the mole fraction of water in feed, γ_{w} was the activity coefficient of water and Pₛₐₜ was the saturation pressure of the water at a given temperature. Since, the water vapor pressure was negligible in the downstream (e.g., vacuum, approximately 10-2 Torr), the ΔP^{sat} was calculated using the only equilibrium vapor pressure of the liquid in the feed side shown in Equation 3. The mole fraction and activity coefficient of water for each saline feed solution in the desalination assessments were evaluated for reporting P_{w} values. Permeability (Pᵢ) was calculated by multiplying the water permeance by the membrane thickness (t, m):

$${P}_{i} = {P}_{w} t \qquad Eq . 4$$

Estimation of water permeance that accounted for variation in the feed conditions and water permeability that displayed the intrinsic water transport properties allowed for a robust comparison with different reference reported across the membrane science community. A student t-test was performed with a confidence level of α=0.05 for significance comparison. Lastly, the salt rejection (SR, %) was estimated by measuring the saline concentration before (c_{feed}) and after (cₚₑᵣₘₑₐₜₑ) the desalination assessment:

$$SR \% = ( 1 - \frac{{c}_{permeate}}{{c}_{feed}} ) \times 100 \% \qquad Eq . 5$$

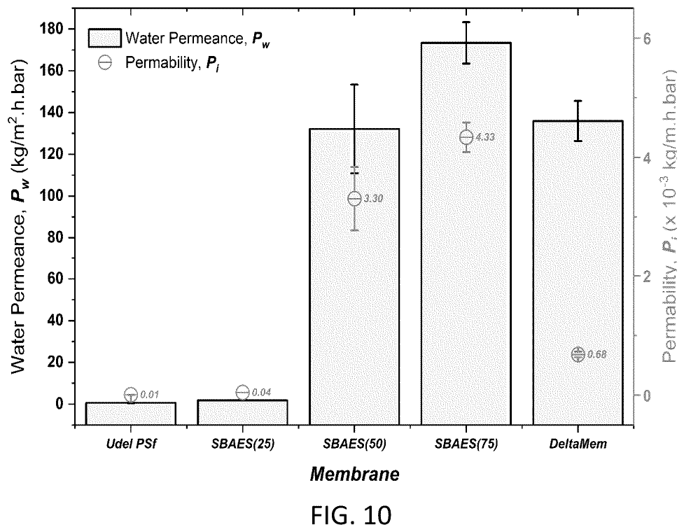

A baseline assessment was conducted to source the water permeance and permeability in deionized water under ambient conditions. Dense membranes with an average thickness of 25 μm were utilized for these assessments. The performance of these membranes was compared to Udel PSf (25 μm) and a commercial pervaporation membrane (DeltaMem), as shown in FIG. 10. The P_{w} for the lowest charge PAES(75)-co-SBAES(25) membrane was 1.78 kg/m²·h·bar, marginally higher than the measured 0.6 kg/m²·h·bar of the Udel PSf. This can be understood in the context of the comparable structures of both polymers, wherein the SBAES(25) copolymer includes three units of PAES and one unit of sulfobetaine-modified PAES in each chain. This similarity also suggested, at low charge concentration, the hydrophobic backbone of the PAES in PAES-co-SBAES copolymers can exert more influence than the hydrophilic zwitterionic charges that effectively impeded the movement of water. Nevertheless, PAES(50)-co-SBAES(50) membranes displayed an improvement in average water permeance of nearly 75-folds (132 kg/m²·h·bar) when compared to PAES(75)-co-SBAES(25) membranes. When compared to the DeltaMem membrane, the average permeance levels were nearly equivalent. In PAES(50)-co-SBAES(50), the equivalent hydrophilic domain holding 50 mol % sulfobetaines enhanced and overlapped the influence of the hydrophobic counterparts. Analogously, PAES(25)-co-SBAES(75) with an average of 173 kg/m²·h·bar exhibited the highest water permeance. This change in permeance values from PAES(75)-co-SBAES(25) to PAES(25)-co-SBAES(75) suggested the hydration capabilities of the sulfobetaines to quench and swell the dense membranes, leading to faster diffusion rates.

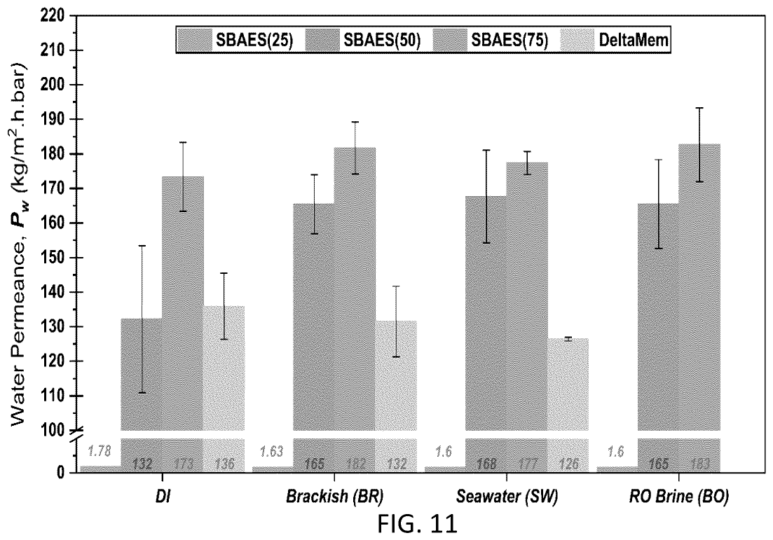

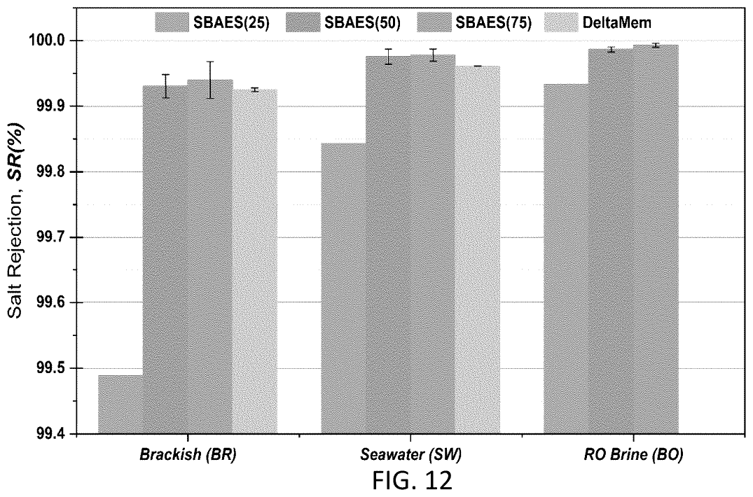

The dense membranes were subjected to an increasing concentration of saline solution to understand the effect of zwitterions on the water permeance in a desalination pervaporation setting. The reference was the water permeances obtained from the deionized water pervaporation tests. FIG. 11 summarizes the water permeances obtained for different synthetic salt solutions. FIG. 12 notes the corresponding salt rejections afforded by the PAES(YY)-co-SBAES(XX) membrane series, as shown in Table 4. The water permeance for PAES(75)-co-SBAES(25) membranes dropped slightly and held constant at 1.6 kg/m²·h·bar in brackish water, seawater, and reverse osmosis brine solutions in contrast to deionized water (e.g., approximately 1.8 kg/m²·h·bar) while displaying 99.48%, 99.84% and 99.93% rejections, respectively. The water permeance of SBAES(50) membranes increased when the deionized water feed was replaced with salt solutions. The average P_{w} values increased from 132 kg/m²·h·bar to approximately 166 kg/m²·h·bar, while displaying an average salt rejection of 99.93%, 99.97% and 99.98% in brackish water, seawater, and reverse osmosis brine solutions, respectively. Additionally, a student t-test further revealed that the noted permeance for all salt solutions were different than deionized water. On the contrary, DeltaMem (with PVA active layer) that possessed an equivalent deionized water permeance as PAES(50)-co-SBAES(50) membranes did not show an increase in permeance in brackish water and reverse osmosis brine salt solutions, holding an average P_{w} of 132 and 126 kg/m²·h·bar with 99.92% and 99.96% rejections, respectively. The permeances for DeltaMem were statistically insignificant for deionized water and salt solutions. The highest zwitterion concentration PAES(25)-co-SBAES(75) membranes recorded the highest average P_{w} of 173 kg/m²·h·bar in deionized water and approximately 180 kg/m²·h·bar across salt solutions, with no statistical difference. Not only the permeances were similar for all salt solutions, but they also afforded an even greater average salt rejection of 99.94% (brackish water), 99.98% (seawater) and 99.99% (reverse osmosis brine) compared to PAES(50)-co-SBAES(50). Overall, this data suggested that regardless of total dissolved solids concentrations, PAES(50)-co-SBAES(50) and PAES(25)-co-SBAES(75) membranes remained insensitive and can dispense pure water permeates. Both the water permeance and salt rejection performances increased with salt concentration, defying the permselectivity trade-off that was typically seen for non-porous membranes.

TABLE 4
Summary of water flux, water permeance, water permeability and
salt rejection for membrane from desalination pervaporation assessments
with different feed saline solutions. PAES(75)-co-SBAES(25) is
denoted as SBAES(25), PAES(50)-co-SBAES(50) is denoted as SBAES(50),
and PAES(25)-co-SBAES(75) is denoted as SBAES(75).

| | | | | |
|---|---|---|---|---|
| | | Water | Water | Salt |
| | Water Flux | Permeance | Permeability | Rejection |
| Dense | J_{w} | P_{w} | Pᵢ | SR |
| Membrane | kg/m² · h | (kg/m² · h · bar) | (kg/m · h · bar) × 10⁻³ | (%) |

Deionized Water

| | | | |
|---|---|---|---|
| Udel PSf | 0.015 ± 0.002 | 0.59 ± 0.08 | 0.006 ± 0.004 |
| SBAES(25) | 0.045 ± 0.00 | 1.78 ± 0.00 | 0.044 ± 0.00 |
| SBAES(50) | 3.38 ± 0.54 | 132.13 ± 21.27 | 3.30 ± 0.53 |
| SBAES(75) | 4.43 ± 0.25 | 173.36 ± 9.92 | 4.33 ± 0.25 |
| DeltaMem | 3.47 ± 0.25 | 135.92 ± 9.61 | 0.68 ± 0.05 |

Brackish Water

| | | | | |
|---|---|---|---|---|
| SBAES(25) | 0.041 ± 0.00 | 1.62 ± 0.00 | 0.040 ± 0.00 | 99.489 |
| SBAES(50) | 4.19 ± 0.22 | 165.47 ± 8.55 | 4.14 ± 0.21 | 99.93 |
| SBAES(75) | 4.60 ± 0.19 | 181.69 ± 7.54 | 4.54 ± 0.19 | 99.939 |
| DeltaMem | 3.32 ± 0.26 | 131.52 ± 10.20 | 0.66 ± 0.05 | 99.925 |

Seawater

| | | | | |
|---|---|---|---|---|
| SBAES(25) | 0.039 ± 0.00 | 1.59 ± 0.00 | 0.039 ± 0.00 | 99.843 |
| SBAES(50) | 4.15 ± 0.33 | 167.68 ± 13.40 | 4.19 ± 0.33 | 99.975 |
| SBAES(75) | 4.39 ± 0.08 | 177.40 ± 3.34 | 4.43 ± 0.08 | 99.977 |
| DeltaMem | 3.13 ± 0.01 | 126.42 ± 0.54 | 0.63 ± 0.002 | 99.961 |

Reverse Osmosis Brine

| | | | | |
|---|---|---|---|---|
| SBAES(25) | 0.038 ± 0.00 | 1.60 ± 0.00 | 0.040 ± 0.00 | 99.933 |
| SBAES(50) | 3.93 ± 0.30 | 165.48 ± 12.87 | 4.14 ± 0.32 | 99.986 |
| SBAES(75) | 4.33 ± 0.25 | 182.64 ± 10.66 | 4.56 ± 0.26 | 99.992 |
| DeltaMem | — | — | — | — |

An accepted mechanism of water and solute transport in pervaporation was based on a solution-diffusion model. In this model, the transport in the selective polymeric membrane was diffusive in nature, wherein, there is sorption of components from the liquid mixture and ensuing diffusion through the free volume of the membrane matrix, followed by evaporation of the adsorbed species as vapor from the permeate side of the membrane. Thus, following the postulated permeability-selectivity trade-off for dense polymeric membranes, an increased water permeability was accompanied with even greater salt permeabilities. Given that the PAES(50)-co-SBAES(50) copolymers were constructed with similar thickness, the reported water permeabilities scaled proportionally to the water permeances observed. This non-linearity in the current data suggested that for zwitterionic dense membranes, the transport can not be described by a simple diffusion process and there existed interactions between the feed penetrants, ions, and membrane properties amounting to a complex transport mechanism.

For zwitterionic polymers, the presence of opposite charges made them stimuli-responsive to external triggers such as pH, temperature, and salts. The incongruity in the SBAES(50) water permeance values can be clarified by considering the anti-polyelectrolyte effect of zwitterions.

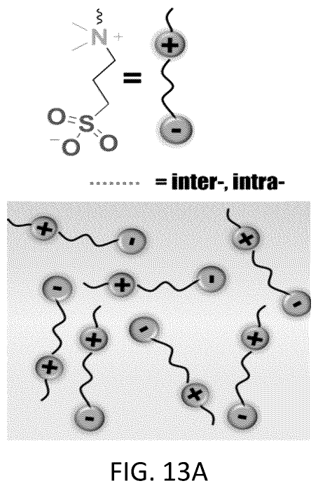

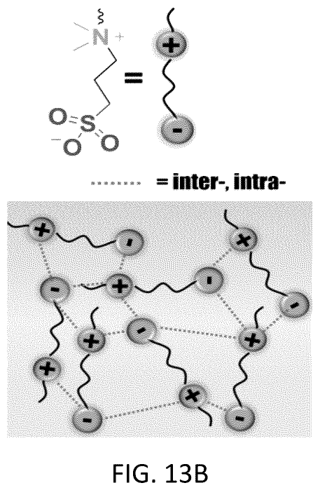

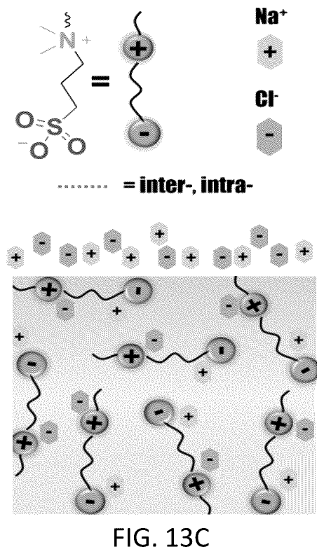

The increased permeance in the PAES(50)-co-SBAES(50) membranes can be a feature of the anti-polyelectrolyte effect. An illustration of this for the PAES(YY)-co-SBAES(XX) copolymers is shown in FIGS. 13A to 13C. The salt ions in the electrolyte solution interfacing the dense membranes can screen the inter- and intra-chain electrostatic associations (e.g., zwitterion-zwitterion), as shown in FIGS. 13A and 13B. The screening effect led to dissociation of the crosslinks and extension of zwitterionic chains, as shown in FIGS. 13B and 13C. As a result, more ionic groups become accessible for hydration, allowing them to swell more freely and enhance the water flux.

The observed low permeance for PAES(75)-co-SBAES(25) membranes can be attributed to the changes in the microstructure that arise due at least in part to the zwitterion charges in the membranes. At low concentrations, the zwitterions can remain in isolated ionic domains from the dominant non-ionic hydrophobic backbone of poly(arylene ether sulfone) and thus, hinder the full hydration capacity of the zwitterions. At high concentrations for PAES(25)-co-SBAES(75) membranes, the isolated hydrophilic clusters grew in size, amounting to large and continuous channels of ionic rich domains supplementing the water transport inside the membranes. In contrast to the PAES(50)-co-SBAES(50) membranes, the PAES(25)-co-SBAES(75) membranes show negligible differences in the permeance in deionized water and salt solutions. This suggested that in the PAES(25)-co-SBAES(75) membranes, features of the anti-polyelectrolyte effect may not be able to fully hydrate the chains in the PAES(25)-co-SBAES(75) membranes, which are masked by the large ionic aggregates. Nevertheless, the cooperation between these competing effects supplemented a constant water permeance regardless of an increasing brine concentration. Finally, noting the differences in the water permeances across the PAES(75)-co-SBAES(25), PAES(50)-co-SBAES(50), and PAES(25)-co-SBAES(75) membranes, the transport mechanism in electrolyte solution can be understood in terms of solution diffusion and ionic interactions. For example, at certain zwitterion concentrations, the diffusion of water was amplified by the anti-polyelectrolyte properties, coupled with a continuous transport of water shells in the ionic rich phase formed via adsorption of water molecules.

What is claimed is:

1. A method of synthesizing zwitterionic-functionalized polysulfone copolymer, the method comprising:
reacting bisphenol A, 2,2′-diallyl bisphenol A, and 4,4′-difluorodiphenyl sulfone to yield a poly(arylene ether sulfone) polymer comprising allyl groups;
modifying the allyl groups to yield a poly(arylene ether sulfone) polymer comprising tertiary amine groups; and
modifying the tertiary amine groups to yield a copolymer comprising poly(aryl ether sulfone) and sulfobetaine arylene ether sulfone, wherein the sulfobetaine arylene ether sulfone is bonded to the poly(arylene ether sulfone) backbone.

2. The method of claim 1, wherein the copolymer comprises about 1 mol % to about 99 mol % sulfobetaine arylene ether sulfone.

3. The method of claim 1, wherein a number average relative molecular weight of the sulfobetaine modified poly(aryl ether sulfone) copolymer is in a range of about 3 kDa to about 165 kDa.

4. The method of claim 1, wherein modifying the allyl groups comprises a thiol-ene click reaction.

5. The method of claim 1, wherein modifying the tertiary amine groups comprises a ring opening reaction of a 1,3-propanesultone on the tertiary amine groups.

6. A membrane comprising a copolymer prepared according to the method of claim 1.

7. A method of preparing a membrane comprising the zwitterionic-functionalized polysulfone copolymer of claim 1, the method comprising:
forming a solution comprising the copolymer;
casting the solution to yield a membrane precursor; and
drying the membrane precursor to yield the membrane.

8. The method of claim 7, wherein the copolymer is dried before forming the solution.

9. The method of claim 7, wherein the solution further comprises dimethylformamide.

10. The method of claim 7, wherein drying the membrane comprises heating the membrane precursor at a temperature in a range from about 20° C. to about 80° C.

11. A membrane prepared according to the method of claim 7.

12. A pervaporation module comprising:
the membrane of claim 11.

13. The pervaporation module of claim 12, wherein a salt rejection of the membrane exceeds 99% for brackish water, seawater, and reverse osmosis brine.

14. The pervaporation module of claim 12, wherein the membrane is supported by a porous stainless-steel frit plate.

15. The pervaporation module of claim 12, wherein a first side of the pervaporation module is continuously circulated with a feed solution.

16. The pervaporation module of claim 15, wherein the feed solution comprises deionized water, a saline solution, or any combination thereof.

17. The pervaporation module of claim 16, wherein the saline solution is prepared with total dissolved solids ranging from about 10000 ppm to about 75000 ppm.

18. The pervaporation module of claim 12, wherein a second side of the pervaporation module is drawn with a vacuum.

19. A zwitterionic-functionalized polysulfone copolymer comprising:
poly(arylene ether sulfone); and
sulfobetaine arylene ether sulfone,
wherein the sulfobetaine arylene ether sulfone is bonded to the poly(arylene ether sulfone) backbone, and a relative number average molecular weight of the zwitterionic-functionalized polysulfone copolymer is in a range of about 80 kDa to about 165 kDa.

20. The zwitterionic-functionalized polysulfone copolymer of claim 19, wherein the copolymer comprises about 1 mol % to about 99 mol % sulfobetaine arylene ether sulfone.
